(19) United States
(12) Patent Application Publication
(10) Pub. No.: US 2004/0038189 A1
(43) Pub. Date: Feb. 26, 2004

(54) Soccer-tennis training apparatus

(76) Inventors: Edward J. Wilgenburg, Grand Haven, MI (US); Elizabeth Anne Wilgenburg, Grand Haven, MI (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 10/645,275

(22) Filed: Aug. 21, 2003

Related U.S. Application Data
(60) Provisional application No. 60/440,267, filed on Jan. 15, 2003.
(60) Provisional application No. 60/405,242, filed on Aug. 22, 2002.

(51) Int. Cl. G09B 9/00; G09B 19/00; A63B 69/00

(52) U.S. Cl. 434/251

(57) ABSTRACT

A portable game and training apparatus for teaching soccer skills. The apparatus consists of a telescoping horizontal cross bar and two identical support structures for each end of the horizontal cross bar. The telescoping horizontal cross bar connects to the support structures using fittings made of molded plastic, PVC, graphic, or other material known to those skilled in the trade. The apparatus is used for a soccer training game known by many different names including soccer-tennis, foot-tennis, futbol-tennis, over-the-net-soccer, and the like. The apparatus may also be used as a small-sided goal and as hurdles, thus providing soccer coaches and players with multiple training options. The apparatus may be employed indoors or outdoors on any surface. The apparatus can be assembled or disassembled in a short period of time and fits easily in any car, van, SUV, or any other vehicle.

### CROSS REFERENCE TO RELATED APPLICATIONS

This application claims priority of U.S. provisional patent application Serial No. 60/440,267, filed Jan. 15, 2003 and of U.S. provisional patent application Serial No. 60/405,242, filed Aug. 22, 2002.

### BACKGROUND OF THE INVENTION

1. Field of the Invention

The present invention generally relates to recreational and sports training equipment, and particularly to a portable training apparatus for several soccer-related activities and games.

Soccer is the most popular sport in the world and it continues to grow in popularity in the United States. The United States men's national team continues to improve as evidenced by their recent performance in the 2002 World Cup. The United States women's national team is often regarded as the best in the world. Although the United States soccer programs are improving, the United States still consistently ranks behind several countries like Germany and Brazil where soccer is considered a “religion.” In order to become a country that consistently develops top-level players, players need training devices and games that are fun and hone their skills.

Traditionally, soccer is taught through drills that emphasize various soccer skills and through actual playing practice. Although drills are necessary to develop soccer skills, many players do not find the drills to be enjoyable and they are not prone to practice the drills outside a structured coaching environment.

It is an object of the present invention to provide a training apparatus that will teach soccer skills in a fun game-like environment. The product of the present invention is designed to provide multiple training options for soccer coaches and players.

One training option is soccer-tennis. The game of soccer-tennis is designed to develop ball handling skills under the stress of competition. Players are forced to handle balls using restricted touches and play balls back with accuracy and tactical reasoning. Players develop touch and enhanced decision making skills while trying to engineer tactics to successfully outplay their opponents.

Soccer-tennis is played over a net with grids on either side of the net similar to tennis, volleyball, or badminton. Soccer-tennis is a fun and challenging game that can be played with two (2) or more persons. Soccer-tennis can be played in a tournament format or played at home, practice, soccer camps, parks, and the like. The product of the present invention provides for a portable apparatus that serves the function of the “net” needed for the soccer-tennis game.

A second training option is a small-sided goal. One of the best ways for players to develop their soccer skills is by playing small-sided games (i.e., 3 vs. 3, 4 vs. 4). This gives players more opportunities to touch the ball during a practice session. The product of the present invention provides for a portable apparatus that serves the function of a small-sided goal.

A third training option is hurdles for plyometric and other fitness drills. Plyometric drills provide a variety of agility and fitness options for coaches and players. The product of the present invention provides for a portable apparatus that serves the function of hurdles that are adjustable in height and width.

Other training options may be developed based on the ingenuity of coaches and players.

### SUMMARY OF THE INVENTION

One objective of the present invention is to provide a training apparatus for soccer that is fun and challenging, improves a player's skills, and has multiple uses.

Another objective of the present invention is to provide a soccer training apparatus that allows very rapid and simple setup.

Yet another object of this invention is to provide a soccer training apparatus that players and coaches can fit easily in any car, van, SUV or other vehicle, thus allowing the apparatus to be used at home and at practice.

Yet another object of this invention is to provide a soccer training apparatus that can be played on any surface, including grass, sand, dirt, asphalt, concrete, carpet, hardwood floors, and the like. This allows a player to play year round.

The present invention is a portable, easily-assembled soccer and physical education training apparatus which may be used indoors and outdoors. The apparatus requires no tools and can be assembled or disassembled in a short period of time, preferably less than one minute. Telescoping poles allow the apparatus to “fold” to a portable size to fit in a trunk or backseat of a car or other vehicle, and conveniently fits into a bag for carrying.

### BRIEF DESCRIPTION OF THE DRAWING FIGURES

FIG. 1 is an oblique view of one embodiment of a soccer-tennis training assembly embodying the instant invention;

FIG. 2 is an end view of the soccer-tennis training assembly embodying the instant invention;

FIG. 3 is a side view of the soccer-tennis training assembly embodying the instant invention;

FIG. 4 is a top view of the soccer-tennis training assembly embodying the instant invention;

FIG. 5 is a fragmentary oblique view of a joint engaging a plurality of telescoping member assemblies;

FIG. 6 is a fragmentary side view of a foot engaging a telescoping member assembly;

FIG. 7 is a fragmentary oblique view of a telescoping member assembly;

FIG. 8 is a fragmentary oblique view from another angle of a telescoping member assembly;

FIG. 9 is an isometric view of an alternate embodiment of the invention;

FIG. 10 is an isometric view of yet another embodiment of the invention; and

FIG. 11 is a fragmentary sectional view of a coupler assembly.

### DETAILED DESCRIPTION OF THE INVENTION

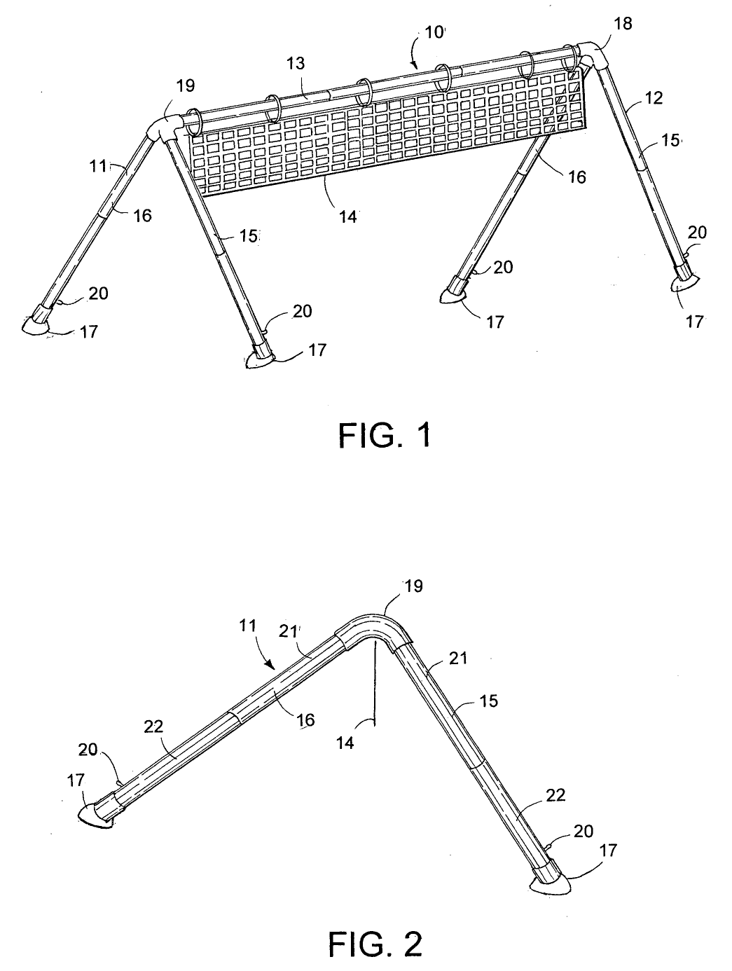

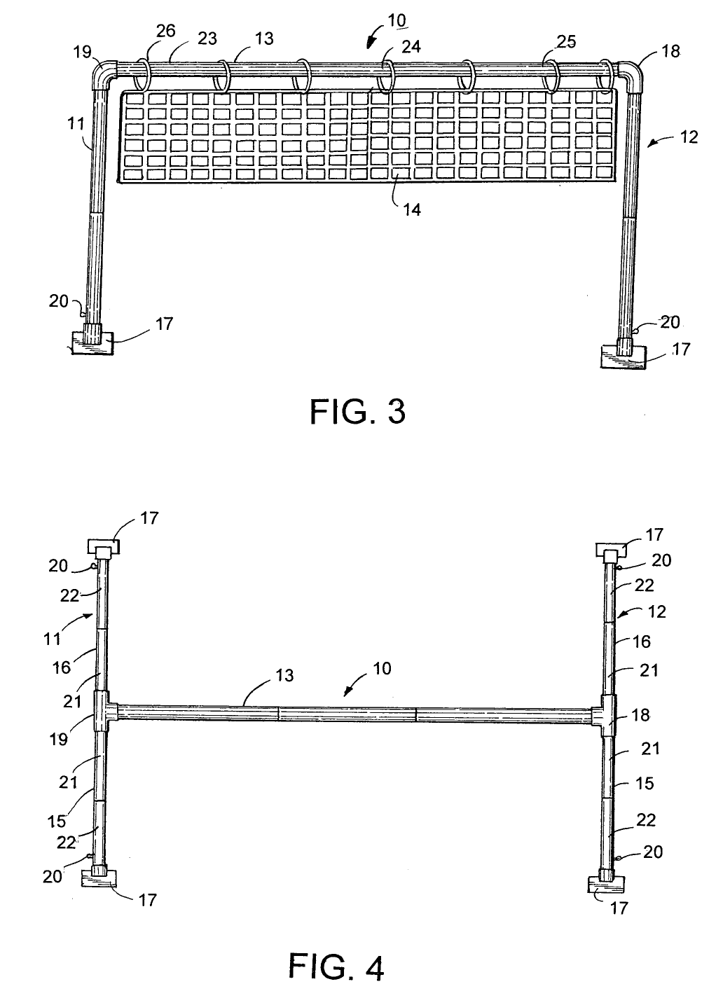

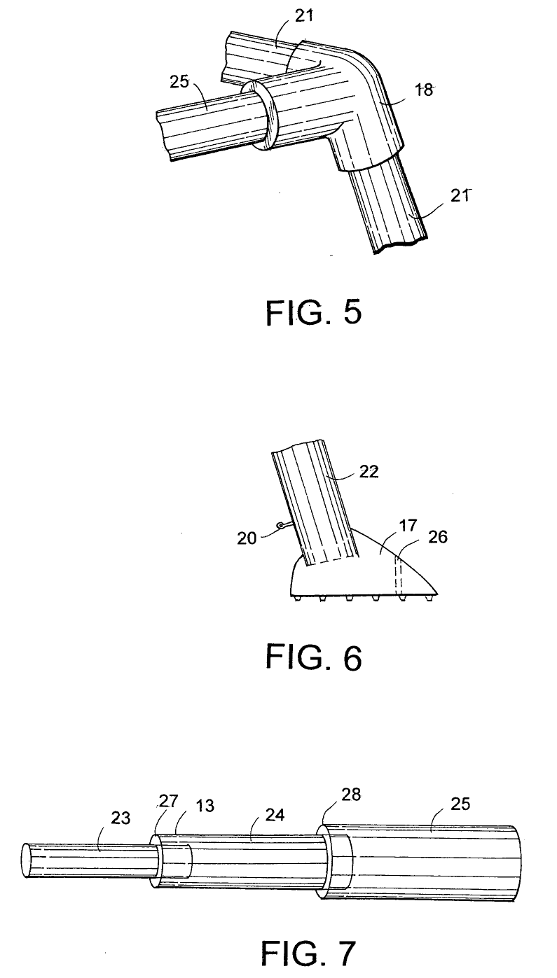

For purposes of the following description, the terms “upper,” “lower,” “left,” “right,” “rear,” “front,” “vertical,” “horizontal,” and derivatives of such terms shall relate to the invention as oriented in FIG. 1. However, it is to be understood that the invention may assume various alternative orientations, except where expressly specified to the contrary. It is also to be understood that the specific devices and process illustrated in the attached drawings, and described in the following specification are simply exemplary embodiments of the inventive concepts defined in the appended claims. Specific dimensions and other physical characteristics relating to the embodiments disclosed herein are not to be considered as limiting, unless the claims expressly state otherwise. Referring to the drawing figures, one embodiment of the invention is shown with particular application to a soccer-tennis training apparatus 10 compromising a left support assembly to be attached to a cross bar member assembly 13 which in turn is attached to the right support assembly 12 at the other end. Attached and extending from the cross bar member assembly 13 is a net 14. In the preferred embodiment this net 14 will hang vertically below the cross bar member assembly 13.

Referring now to FIG. 2, the left support assembly 11 of the soccer-tennis training apparatus includes a front leg support assembly 15 and a rear leg support assembly 16, which are engaged to the cross bar member assembly 13 with the left joint 19. Each of the front leg support assembly 15 and rear leg support assembly 16 compromise a plurality of telescoping legs. Each leg support assembly compromises an upper telescoping leg 21 attached to the respective right joint 18 or left joint 19. Each respective lower telescoping leg 22 connects the upper telescoping leg 21 to the foot 17.

Referring now to FIG. 6, the foot 17 is connected to the lower telescoping leg 22. On the front or rear respective side of lower telescoping leg 22, a hole 26 exists to allow the passage of a stake, pole or other object to aide in support of this structure. A latch 20 exists on each respective lower telescoping leg 22 to both restrict and allow vertical movement of each leg support assembly 15, 16.

Referring now to FIG. 7, the cross bar member assembly 13 compromises a plurality of telescoping members held together by couplings. In a preferred embodiment the cross bar assembly consists of three telescoping members. The outer telescoping member 25 is connected to the right joint 18 or left joint 19. The opposite end of outer telescoping member 25 is connected to the intermediary telescoping member 24 by coupling 28. The opposite end of intermediary telescoping member 24 is connected to the inner telescoping member 23 by a coupling 27. In turn, the inner telescoping member 23 is connected to either the left joint 19 or right joint 18.

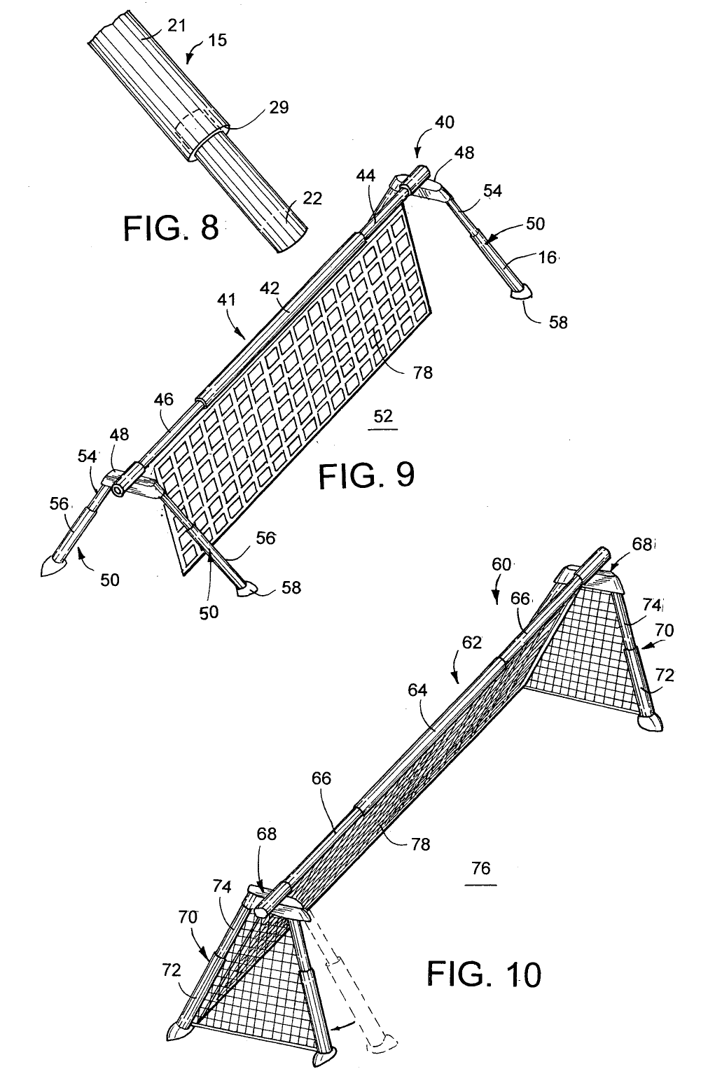

Referring to FIG. 8, each respective front leg support assembly 15 and rear leg assembly 16 compromises an upper telescoping leg 21 and lower telescoping leg 22. These two portions of each respective leg support assembly are connected using a coupling 29.

FIGS. 9 and 10 illustrate an alternate embodiment of the invention which is constructed in a manner to permit a change in the configuration and ultimately use of the invention so it is a more versatile and functional training device. In particular, FIG. 9 illustrates the assembly 40 including a central horizontal member 42 which telescopically receives extensions 44 and 46 on opposing ends. It is preferred that telescoping extensions 44 and 46 are received substantially within central member 42 and may be fixed in any desired position between a fully retracted and fully extended position by a simple twist of the rod to lock it in place. In this manner, the bar assembly 41 may be adjusted to a variety of lengths.

The outer or free ends of the extensions 44 and 46 are each slidably received within a coupler assembly 48 which in turn is attached to legs 50 to support the horizontal bar assembly 41 above the ground 52. Just as with horizontal bar assembly 42, it is preferred that each leg assembly 50 include one member 54 which is telescopically received within a second member 56 and fixed at any one position between a fully extended and fully retracted position by turning one member 54 within the other member 56. Alternatively, it is contemplated member 56 may be fitted with a set screw or knob that can be tightened against member 54 to fix it into position. In this manner, the height of each of the legs 50 can be substantially the same to support the bar member 41 above the ground 52. The bottom of each of the leg assemblies 50 is preferably fitted with a foot member 58 to provide traction on a variety of surfaces as well as increase the footprint of the stand assembly so that it doesn't subside in softer, sandy soils.

FIG. 10 illustrates an alternate configuration of the invention wherein a bar assembly 62 is formed by a central tube member 64 telescopically received by, or receive end members 66. As in the previous embodiment, the telescopic position of the end members 66 may be fixed with respect to the central member 64 by any one of a number of locking assemblies including set screws or expanding inner locking mechanisms.

The outer ends of the end elements 66 are received in fixed relationship by coupler assembly 68. The coupler assembly 68 in turn receives legs 70 which are formed by one member 72 receiving coaxially a second member 74. The end of member 74 is received within the coupler assembly 68 to support the bar assembly 62 above the ground 76.

Referring to FIGS. 9 and 10 together, the drawing figures illustrate the different embodiments and configurations of the invention available for a single assembly. In FIG. 9, a net or drape may be suspended from the bar assembly 41 to hang vertically such that the user can position the invention 40 and use it much in the same manner as a tennis net or similar obstacle. In the configuration illustrated in FIG. 10, the invention permits the user to adjust legs 70 and reposition the drape or net 78 around the legs on one side of the bar assembly 62 and between the legs on the respective ends to form a goal. The telescoping legs, as well as the telescoping horizontal member 62, allow width and height adjustments of the goal assembly to suit the user's particular needs. In this configuration, the user can rapidly configure the invention to provide a goal.

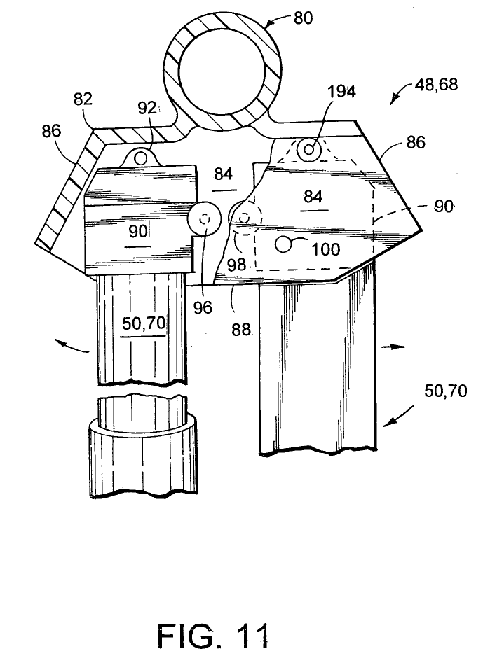

FIG. 11 provides a fragmentary sectional view of the coupler assembly 48, 68 shown previously in FIGS. 9 and 10. To provide the flexibility illustrated in FIGS. 9 and 10, the coupler assembly 48, 68 includes a tubular coupler 80 having inside dimensions essentially equal to or slightly greater than the outside dimensions of the end members 46, 66, such that the members are received within the tubular coupler 80 and retained in frictional lock. Depending from the tubular coupler 80 is a rigid skirt 82 having substantially vertical longitudinal side walls 84 transitioning to inclined end walls 86 and open along the bottom edge 88. Pivotally coupled between the side walls 84 are caps 90. Each cap 90 includes a clevis 92 at an upper end which is pivotally fixed by a pin 94 such as a rivet or other coupler, extending between the side walls 84. A second clevis 96 is found on the exterior surface of each cap on the inwardly facing vertical side walls. The clevis 96 is adapted to receive a detachable pin or fastener 98 passed through one of two holes 100 formed in the side walls 84. Fixing pin 98 in one of the two angularly disposed holes 100 proximate each leg 50, 70 permits the legs to be adjusted both vertically, both inclined, or one inclined and the other vertical, depending on the particular application. The horizontal position of the bar assembly 41, 62, may then be adjusted by changing the vertical position or length of each of the legs 50, 70.

The combination of the telescoping bar assembly 41, 62, together with the telescoping adjustment of the legs 50, 70 and the detachability of the horizontal bars 41, 62 from the couplers 48, 68, permits easy erection and disassembly of the invention or adjustment for a particular requirement. Modification of the invention described above will occur to those skilled in the art and those who make or use the invention. Therefore, it is understood that the embodiments shown in the drawings and described herein are merely for illustrative purposes and not intended to limit the scope of the invention, which is defined by any claims in a subsequent or related application and interpreted according to the principles of patent law including the doctrine of equivalents.

I Claim:

1. A soccer training apparatus for improving skills, stamina, strength and agility, comprising:
a first and a second leg assembly; and
a cross member having a first and a second end adapted to receive said first and said second leg assembly, respectively, for supporting said cross member a predetermined distance above a reference surface, wherein said cross member provides an obstacle over which a user may jump to improve strength, or kick an object such as a ball to improve skills and agility.

2. An apparatus for playing a game of soccer tennis, comprising:
a barrier member of predetermined length and having a first and a second end;
a first support member at said first end of said barrier member, and a second support member at said second end of said barrier member for supporting said barrier member a predetermined distance above the ground;
wherein said barrier member provides a reference over which at least one player volleys a ball with their feet, head, chest or other part of their body.

3. An apparatus for use by one or more players for volleying a ball using any part of their body except their hands, comprising:
a cross bar of predetermined length; and
a first and a second support member attachable to opposite ends of said crossbar for supporting said crossbar in a generally horizontal orientation above a surface and providing a reference height over which the ball is to be volleyed.

4. A method for playing soccer tennis, comprising the steps of:
supporting a crossbar of predetermined length at a predetermined height above a playing surface by a first and a second support assembly attachable to opposite ends of said crossbar;
establishing a playing field substantially divided into two halves by said crossbar; and
with a player's feet, volleying a ball from one half of said playing field, over said crossbar, to an opposite half of said playing field.

5. A method for one or more persons to play a game of soccer tennis, comprising the steps of:
providing a first and a second support assembly;
supporting a cross member in a substantially horizontal orientation between said first and said second support assembly, said substantially horizontal cross member; and
kicking a ball in volleys over said cross member.

6. The method as defined in claim 5, further comprising the steps of positioning a player on opposite sides of said cross member.

7. The method as defined in claim 5, further comprising the steps of kicking the ball over the cross member with at least one touch.

8. An apparatus for use in playing a game of soccer tennis, comprising:
a first and a second support assembly; and
a cross member assembly supported above a playing surface by said first and said second support assemblies.

9. The apparatus as defined in claim 8, wherein said first and said second support assemblies further include:
at least one leg, and
a coupler attached to one end of said at least one leg.

10. The apparatus as defined in claim 8, wherein said first and said second support assemblies are adjustable in length.

11. The apparatus as defined in claim 8, wherein said cross member is a predetermined length.

12. The apparatus as defined in claim 8, wherein said cross member is adjustable in length.

13. The apparatus as defined in claim 8 wherein said first and said second support assemblies comprise:
a first tubular member of predetermined diameter and length;
a second tubular member telescopically received within said first tubular member; and
a locking mechanism for fixing a relative position of said second tubular member to said first tubular member.

14. The apparatus as defined in claim 8, wherein said cross member comprises:
a first tubular member of predetermined length and diameter;
at least a second tubular member telescopically received within said first tubular member; and
a locking mechanism interconnecting said first and second tubular member in a fixed relative position.

15. The apparatus as defined in claim 8, wherein each of said first and second support assemblies comprises:
a coupler for interconnecting a respective one of said support assemblies to said cross member; and
a first and a second tubular assembly, each having a first end coupled to said coupler for providing a stanchion for said cross member.

16. The apparatus as defined in claim 8, further comprising a coupler detachably coupled to an end of said cross member as well as one end of one of said first and second support assemblies.

17. The apparatus as defined in claim 8, wherein each of said first and second support assemblies are pivotally coupled to an opposite end of said cross member.

18. An apparatus for use as a goal, comprising:
a first and a second support assembly; and
a cross member assembly supported above a playing surface by said first and said second support assemblies:
